(19) United States
(12) Patent Application Publication
(10) Pub. No.: US 2001/0024165 A1
(43) Pub. Date: Sep. 27, 2001

(54) Lan/wan automatic sensor reading system

(76) Inventors: Henry B. Steen III, Bowling Green, KY (US); David B. Mundle, Franklin, TN (US); George J. Cole, VanLeey, TN (US); James T. Karam, Goodlertsville, TN (US); Joseph E. Ahler, Franklin, TN (US)

Correspondence Address: Sheldon H. Parker, Parker & DeStefano, Suite 300, 300 Preston Ave, Charlottesville, VA, 22902, US

(21) Appl. No.: 09/739,592

(22) Filed: Dec. 18, 2000

Related U.S. Application Data
(63) Continuation-in-part of application No. 09/545,379, filed on Apr. 7, 2000.
(60) Provisional application No. 60/128,513, filed on Apr. 9, 1999.
(60) Provisional application No. 60/129,708, filed on Apr. 16, 1999.

(51) Int. Cl. H04M 3/00

(52) U.S. Cl. 340/870.01; 455/420

(57) ABSTRACT

The invention combines multiple technologies to create a low-cost, self-powering local area network (LAN) for the collection of data from water, electric, and natural gas meters and the wireless transfer of the meter readings to a solar powered, wide area network (WAN). The WAN collects the data and re-transmits the readings to the secure server via satellite, cellular, or radio frequency in bulk data transmission. The utilities can view, download to billing software, and manage the meter readings in a much more cost efficient and less labor-intensive manner that any system currently available.

### CROSS-REFERENCE TO RELATED PATENT APPLICATIONS

This application is a continuation-in-part of co-pending U.S. Ser. No. 09/545,379 filed Apr. 7, 2000, which is a continuation-in-part of provisional application Serial No. 60/128,513 filed Apr. 9, 1999 and provisional Serial No. 60/129,708 filed Apr. 16, 1999. This application incorporates by reference, as though recited in full, the disclosure of the foregoing co-pending application.

### FIELD OF INVENTION

The invention relates to the wireless collection of data from multiple, remote sensors at a centralized collection unit and the transmission of the collected data to one or more remote locations.

### BACKGROUND OF THE PRIOR ART

Utility companies have been burdened with the labor intensive and cumbersome task of collecting the meter readings, managing the data from the field into the accounting area, and finally to the billing and collection of the invoices from the residential customers. Prior to disclosed technology advances, each residence was provided with a mechanical meter for individual service from respective water, electric and natural gas utilities. These meters are normally manually read with utility labor by physically visiting each meter at the residence and. recording the previous month's usage into written route book for delivery to accounting personnel. This process involved labor, motorized transportation, and soft costs, such as insurance, taxes, etc. Once the readings from the meter were obtained, accounting personnel manually transferred the readings into a database for billing and collection of the invoices for service. Again, this process involved extensive labor as well as soft costs.

Relatively recent advances in technology have improved the efficiency of the collection and data handling using short-range radio frequency technology to collect the meter readings. A radio transmitter has been attached to the mechanical meter, however this technology still requires labor to periodically visit each individual meter. Further efficiency gains were achieved through the use of a radio receiver installed in a vehicle or a hand-held wand. The vehicle installation would require a slow drive-by the meter to have the receiver collect the data, or a hand held wand would physically touch a short antenna for transference of the meter reading to the wand. These receivers could then be taken back to the utility for direct download into the database for the billing and collection process.

These efficiency gains were improvements over the manual readings of the meters and handling of the data by the utility. These approaches, however, still required the manual visit to each meter location and—time—downloading the data to the billing system. The physical meters could be read much more quickly which reduced manpower, vehicular, and soft costs. And the data was transferred from the mobile receiver to the database, which again reduced manpower and data handling. Remaining system negatives include prohibitive capital costs, software and hardware requirements, and providing a reliable and cost-effective power solution for the individual radio transmitter in the individual meters.

### SUMMARY OF THE INVENTION

A data acquisition unit for the collection and transmission of data received from a sensor uses a sensor interface to receive and count, or otherwise log, signals from the sensor, converting the signals to data signals readable by a microprocessor. The data signals are sent to the microprocessor for storage and prescheduled transmission to a remote receiver. A power supply, either internal such as a battery, external, such as solar, or a combination thereof, provides power to the sensor interface and microprocessor. An antenna, preferably multi-element phase collinear horizontal polarized array, is used to transmit the data signal from the microprocessor to the remote collection unit. The data acquisition unit can be adjacent to the sensor and receive signals through either hardwire, RF or other methods currently available. Alternatively, the data acquisition unit and sensor can be an integral unit. The acquisition unit can use either a transmitter or a transceiver to forward and, in some embodiments, receive and transmit signals. In some embodiments, where applicable, multiple acquisition units at a single location can forward data to a single acquisition unit that transmits the data to the collection unit.

11. The collection unit is remotely located from the various data acquisition units and can receive data signals from multiple units over a predetermined distance. The collection unit uses an antenna, preferably two or more horizontally polarized array stacked units, to collect the data signals from the acquisition units. A data collector within the collection unit has a transceiver to receive and transmit the data signals and ID from the microprocessor. The unit further has a microcontroller tp process the data signals and ID, and storage to store the data signals and ID for subsequent analysis. The collection unit can transmit the data signals, at predetermined times, to a centralized server at a remote location or the collection unit can contain analysis software for control of the data signals. The data collector is programmed with the ID for each of the data acquisition units, thereby enabling the data collector to activate predetermined notifications if one of the data acquisition units does not transmit.

Preferably the data acquisition unit uses a time domain collision avoidance system, such as an algorithm, to monitor the preprogrammed transmission schedule. This method of avoiding multiple transmissions within the same time domain from multiple transmitters to a single collection unit uses deterministic timing, randomization and duplicate transmission, by determining a data cycle; determining multiple transmission cycles within said data cycle; determining multiple time slots within said transmission cycle; and assigning a time slot to each transmitting unit. Each of the transmitting units is programmed with a unified start time, with the transmitting units logging time based on that start time. A random transmission period within each time slot is chosen by the transmitting unit for each transmission, thereby considered a first time slot within the transmission cycle with subsequent time slots moving in relation to the first time slot on a predetermined pattern, thereby enabling each transmission to be at a different time from a previous transmission. Each of the transmitting units transmits multiple transmission periods within each of the time slots.

A multi-element phase collinear horizontally polarized array antenna for horizontal transmission has at least two driven elements etched into a base. Each of the said driven elements having a phasing and feed system and a gamma match. The antenna has an impedance matching network and a signal feed. The horizontal polarization increases transmission reliability by increasing gain. Multiples of the antenna are stacked to receive horizontally polarized transmissions from a ground level antenna.

### BRIEF DESCRIPTION OF THE DRAWINGS

The advantages of the instant disclosure will become more apparent when read with the specification and the drawings, wherein:

FIG. 1 is a plan view of the sensor unit and interface and collection unit;

FIG. 2 is a plan view of the sensor unit and interface;

FIG. 3 is a plan view of an alternate sensor unit;

FIG. 4 is a plan view of the data collection unit for use with the disclosed system;

FIG. 5 is a diagramed representation of the disclosed algorithm;

FIG. 6 is a view of the disclosed horizontal polarized collinear multip phase antennat array;

FIG. 7 is a plan view of a communication system for a multi-sensor structure;

FIG. 8 is a cutaway side view of an antenna and transmitter system for use within a manhole.

### DETAILED DESCRIPTION OF THE INVENTION

The disclosed system provides a cost effective method to collect data from one or more individual sensors and transmit the collected data to a remote centralized system. The disclosed system is advantageous in residential areas since it eliminates the need for individual meter reading visits, whether the readings are made by physically reading the meters, or driving by each meter to pick up transmitted signals. Additionally, since the system is capable of collecting data from more than one type of sensor, multiple utilities, e.g. gas, water and electrical, can use the same system, thereby sharing the costs.

Additional savings are achieved by using cost effective transmitters within each data acquisition unit and a single high sensitivity receiver at the collection unit. Since about 2000 transmitters can send data to a single receiver, the cost savings of this embodiment can be dramatic. The use of a high gain antenna system and highly sensitive receiver compensates for the low powered transmitters within each data acquisition unit. The disclosed system also uses other unique techniques, such as transmission collision avoidance scheduling and multi-element phased collinear horizontally polarized array antenna, to increase the reliability of the transmission while maintaining the low cost.

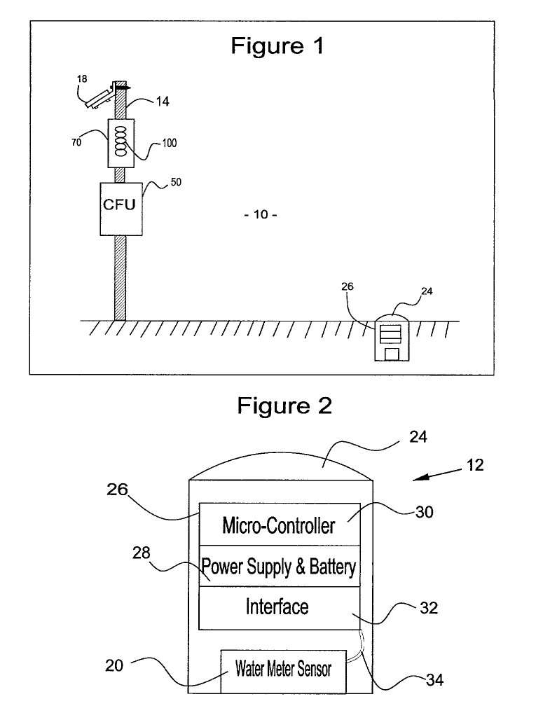

The disclosed system 10 eliminates the manpower and mobile data collection process entirely, enabling direct transmission of data from multiple remote sensors to a user accessible centralized database for the most efficient and cost-effective data monitoring and processing possible. As seen in FIG. 1, the data from the individual sensors 20 is transmitted through a microprocessor based data acquisition device 26 to the collection unit 14, where it is processed and/or transmitted to a third location, via satellite, public or private wireless networks, hardwire, or other communication method. The sensor 20 in this figure is illustrated as an underground installation, however the sensors 20 can be water or power meters installed on, or in, a building, temperature or other sensors incorporated with machinery, traffic counters, or any other sensor or device that registers some form of data. The data registered by the sensor 20 is transmitted to the low power data acquisition device 6 26 through applicable methods, such as hardwiring 34. In most applications the data acquisition device 26 is adjacent to the sensor 20. However in instances where the data acquisition device 26 is collecting data from several sensors simultaneously, the collection can be through hardwire or other applicable methods. For ease of description, the following disclosure is directed to a data acquisition device collecting data from a single sensor, however this is not intended to limit the scope of the invention. The data collected from the sensor 20 is transmitted from the data acquisition device 26 through the antenna 24 to a receiver equipped data collector 50. The data received at the data collector 50 can, at that point, be handled in a variety of methods applicable to the installation.

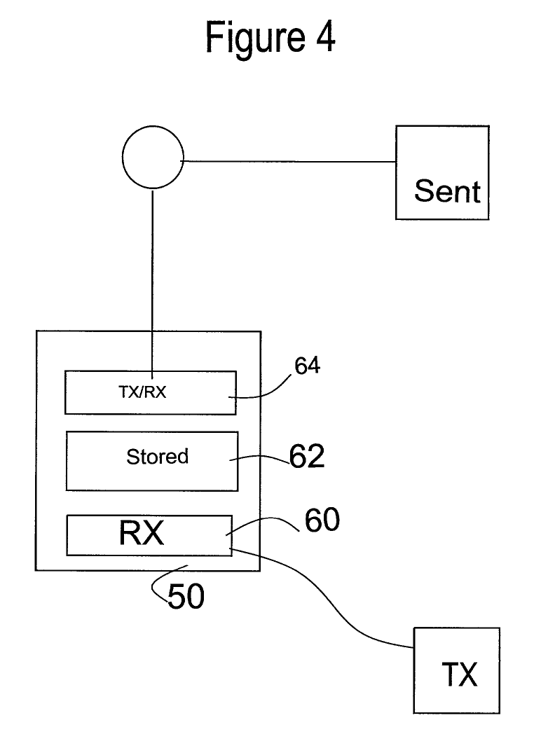

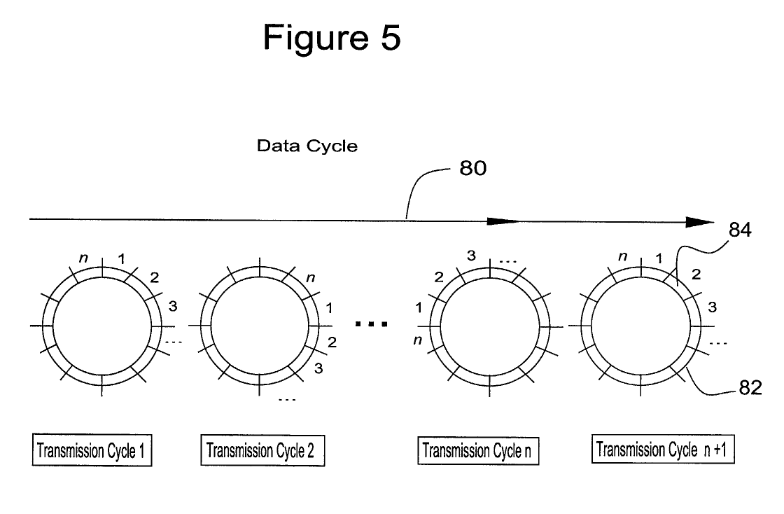

The data collector 50, as illustrated in FIG. 4, is part of the collection unit 14 and is preferably a fixed pole mounted receiver/transceiver to collect and transmit, if applicable, the readings from each individual sensor 20. The data is received by the receiver 60 and stored in the memory of the microprocessor system 62 until transmitted by the transceiver 64. It should be noted that reference herein to a transceiver also includes any type of receiving and transmitting device. For example, when using the Globalstar LEOS satellite system a Qualcomm GSP 1620 satellite packet data modem is used as the “up/down link” transceiver. Where cellular coverage exists a Wireless Link CVDM3 or Standard Communications CMMxxxx V-Burst modem can be used as the transceiver. Also, a NORCOM SDX-1000 can be used as a transceiver or other devices current known in the art. The transmission scheduling is based upon user programmable time periods and can be customized based upon user preference. In systems where the data is being transferred, via the transceiver 64, to a remote, centralized server, the data collector 50 serves as the uplink. Satellite data networks such as Norcomm and Globalstar can be used for the transmission of large quantities of meter readings at a relatively low cost of transmission. Terrestrial data networks, such as Aeris, GSM, and Mobitex can also be utilized to transmit the data to a centralized server location. Aeris and GSM are cellular networks and will allow low-cost, large data messages to be transmitted to the server. This fixed site mounting can either be AC powered or battery operated and can be recharged via solar power through use of a panel 18.

For example, a power company using the disclosed system to determine and bill power usage would collect data from individual sensors, transmit the data to a local collection box and then transmit, via satellite, the data to a centralized location, whether it is the power company central office or a service provider. For optimum effectiveness, the data is transferred to a service provider's central server, remaining unaffiliated with any specific sensor company. In this way, a single system can gather sensor readings for multiple, unaffiliated companies. An example wireless hub, or central, system is disclosed in co-pending Ser. No. 09/545,379 which is incorporated herein as though recited in full. If, however, the power consumption, or other sensor readings, being collected and analyzed are within a defined area, such as a military base, the data collector can also be the analysis or billing entity, without further data transmission. In this embodiment, the foregoing wireless hub application of U.S. Pat. No. 09/545,379 can be modified, as will be evident, for localized use.

The disclosed system can be used to continually monitor the related sensors, such as for power or water usage, or can be programmed to periodically check the sensor status, as in monitoring water levels or temperature.

The sensor and data acquisition combination unit 12 is illustrated in FIG. 2 wherein the sensor 20 is connected to, or incorporated with, the monitoring/transmitting data acquisition device 26. It should be noted that although the sensor 20 is illustrated as a separate device from the data acquisition device 26 in this Figure, the device can also be incorporated into a single, integrated unit. An integrated unit is advantageous in that it would increase efficiency running for years without maintenance. The ability to interface with existing sensors, however, provides companies the ability to use the disclosed system in existing applications. As described herein the sensor will be a separate device, however the integration of the sensor with the data acquisition device will be evident to those skilled in the art in conjunction with the teachings disclosed herein. In the preferred embodiment, the sensor and the microprocessor based data acquisition unit are an integrated unit, combining sensor, counter, power source and transmitter.

The microprocessor based data acquisition device 26 consists of an antenna 24, microprocessor 30 having transmission and/or reception capabilities, power supply 28 and interface 32. It should be noted that the term microprocessor, as used herein, refers to any method or means or system current in the art for storing, transferring and controlling data. The interface 32 receives data from the sensor 20 through wiring, proximity, or other method applicable to the sensor. The interface 32 serves to convert the signals or data received from the sensor 20 into data usable by the disclosed system 10. For example, in electric meters, the data is received as pulses while in liquid flow meters the data could be received as 4-20 ma signal levels. In some cases, an optical method will be used to pick-up the meter activity. The system is designed to interface to all sensors, including but not limited to equipment having a serial data interface. These signals are counted at the interface 32 and are then stored in the microprocessor 30 as quantitative values for subsequent transmission to the data collector 50. The raw data is transmitted as collected values, which are converted into the appropriate units, e.g. kilowatt-hours, gallons or cubic feet, at the final data analysis location.

The microprocessor 30, in this embodiment, receives power from the power supply 28. The power supply 28 can be any direct power, or power storage unit, applicable to the installation. The microprocessor 30 takes the data received from the sensor 20, stores the data and then, based upon a preprogrammed transmission schedule, transmits the data to the data collector 50.

The data acquisition device 26 preferably uses a small, low power consumption transmitter. Preferably the transmitter has the capability of transmitting to about one thousand, two hundred and fifty feet (1250′) or other government or agency determined distance. Within this determined range, transmitter power/radiation levels are used that do not require direct frequency licensing. In other applications, however, longer distances can be required, at which time the transmitter power/radiation levels would be increased to the necessary levels and the appropriate licenses obtained.

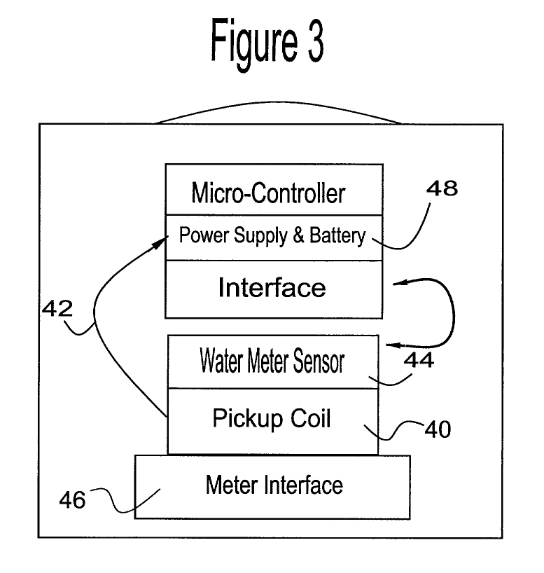

Another important aspect of the disclosed system is the optional ability to recharge the battery using the flow of the monitored fluid or gas allowing the system to have almost a near-permanent power source. This embodiment is compatible with magnetically coupled RTR meters as well as any equivalent. This embodiment, illustrated in FIG. 3, places a pick up coil 40 between the sensor 44 and the sensor interface 46. The movement of the sensor interface 46, in reaction to the substance being monitored generates an electrical current that is transmitted, through wires 42, to the power supply/storage unit 48. For example, water meters use a rotating blade within the sealed meter to monitor the flow of the water. A magnet within the sealed meter case and attached to the blade, rotates, creating a magnetic field. A pick up coil placed on the exterior of the meter case, adjacent to the rotating blade, intrudes into the meter's magnetic field, synchronizing rotation with the interior magnet. The rotation of the magnet within the sealed meter case and the pickup coil that produces power which is stored by the power supply/storage unit 48. In this way, the power supply/storage unit 48 is continually recharged by the meter interface 46. This method can be used alone or combined with solar power or other alternative power sources.

The disclosed differs from the prior in that there is no physical connection between the sealed magnet within the meter case and the pick up coil. In the prior art devices, such as disclosed in U.S. Pat. No. 3,342,071, the meter is entirely redesigned, using a shaft to connect the rotating fins with the motor generator. The disclosed eliminates any intrusion into the sealed meter, thereby eliminating the need for gaskets and the probability of failure.

Although this method of generating and storing power is disclosed in conjunction with a sensor reading device, this system can be incorporated in any unit in which the movement of the substance being monitored provides mechanical motion to which magnetic, or other, means can be used to produce electric current flow.

One of the functions of the code in the microprocessor 30 is to enable the data acquisition device 26 to efficiently and reliably transmit data in harmony with other units to avoid transmission collision with other acquisition units. In wireless networks where multiple transmitters share a single frequency the system must have a scheme that either avoids transmit time collisions or uses acknowledgments to perform retries or both. Some systems use a master-slave technique with the master transmitting a beacon signal to synchronize the slaves. Both of these techniques require that the transmitter also have a receiver to listen for beacons or acknowledgments.

The disclosed system eliminates the remote receiver by using a new collision avoidance system. This system utilizes existing hardware within the disclosed system, thereby keeping costs to a minimum. This Time Domain Collision Avoidance System (TDCAS) uses deterministic timing, randomization, and multiple, same-data transmissions to increase the probability that multiple transmitters on the same frequency will avoid collision and successfully deliver data to the collector box. This system can be in the form of an algorithm or other programming.

Each of the data acquisition units contain a time of day clock synchronized to a universal time base. The TDCAS depends on this synchronization to schedule transmissions and therefore it is critical that each acquisition unit be synchronized to the exact time base. The synchronization is accomplished on the manufacturing line and each data acquisition unit has a battery backed up real-time clock to keep track of this time.

Each data acquisition unit within a single collection box network will transmit its data to the collector box during a predetermined time slot 84 within a larger transmission cycle 82. There are multiple transmission cycles 82 within the data cycle 80, thereby increasing the likelihood of at least one transmission being received by the collection unit. The data cycle 80 represents a time period selected by the user, such as monthly, annually, etc. The transmission cycle 82 is the time over which all data acquisition units will transmit its latest data once to the collection box. A table look-up, or other monitor method, that uses both the current date/time and the data acquisition unit's unique electronic serial number as indexes, determines the time slot 84 within which the data acquisition unit will transmit. The electronic serial number is used to spread out the data acquisition units evenly over the transmission cycle. The data/time information is used to, in effect, rotate the time-slot allocations so that during each successive transmission cycle a given data acquisition unit will transmit during a different slot. Since all data acquisition units have the same time base they all shift by the same number of slots and remain in unique time slots.

When the time slot for a particular data acquisition unit comes up, the acquisition unit will use a random number to determine when, within the designated time slot 84, the transmission should take place. For example, if the time slot 84 is 60 seconds long and the transmission is five (5) seconds, there are twelve (12) units within which to transmit. Which is these, twelve units is used for transmission is randomly selected by the acquisition unit microprocessor. This allows for cases were either multiple data acquisition units have similar electronic serial numbers and are assigned to the same time slot, or when different data acquisition units attempt to transmit during different time slots, but due to clock drift those time slots actually overlap. The data acquisition unit will also transmit its data packet a predetermined number of repetitive times within each slot 84, thus increasing the probability that the data packet will be successfully received at the collection box.

The rotation of the time slot allocations based on date/time is used to avoid external interference. This interference can be either physical or RF based. Physical interference can be objects that are moved close to or over the transmitter and thus block transmission. If the obstruction is a vehicle that is parked over the transmitter some of the time the rotated time slot will cause the transmitter to transmit at different times of the day, some of which will occur when the obstruction is not present. RF interference can also be periodic in nature like wireless home devices that are active some times of the day and not others. The rotated time slot will thus avoid the times when the interferer is active during at least some of the time.

The combination of several techniques within the TDCAA greatly increases the reliability of data transmission from the data acquisition unit to the collector box. These are listed below:

1) Segmenting data acquisition units into time slots over the larger transmission cycle

2) Randomization of transmit time within the designated time slots

3) Pseudorandom rotation of the time slot allocation map

4) Multiple transmissions within the time slot

5) Several transmission cycles over the period of time when the measurement is actually needed to be reported

Although using transceivers would provide data receipt verification, the power consumption would be higher than desired for the system. Therefore, the use of low cost, low powered transmitters that repeatedly send data overcome this problem. It should be noted that in situations where power is not an issue, transceivers can be used, enabling data receipt verification.

A transmission cycle is not necessarily a 24 hour period and is determined at the time of programming based on end use and density of devices and frequency of transmission occurrence per unit.

The disclosed antenna 100 is a multi-element phased collinear horizontally polarized array. Through the use of horizontal polarization, increased communication reliability is achieved by providing superior building penetration. By maintaining the transmission lobe close to the ground, the lower angle of radiation provides better noise immunity. Because of higher gain, the disclosed antenna requires less transmission power to achieve reliable communication. Prior art antennas are typically vertically polarized and do not provide as good control of directivity characteristics.

In prior art systems, building penetration has been a problem because of the interference and absorption caused by metallic vertical construction materials, such as electrical conduits, and metallic wall studs, which are commonly used. Since most absorption is on the vertical plane, the disclosed system overcomes this problem by utilizing horizontally polarized transmissions. The prior art systems have avoided horizontal polarized transmissions since omni directional requirements were difficult requires were difficult to achieve.

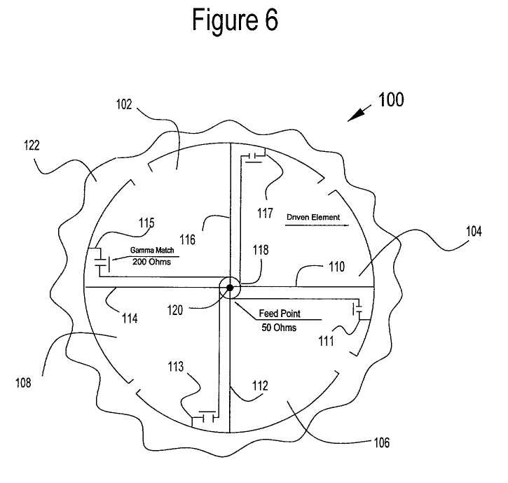

The disclosed antenna 100, illustrated in FIG. 6, attains the omni directional requirement by utilization of multiple correctly phased, actively driven and phased elements 102, 104, 106, and 108. The disclosed antenna 100 is constructed, for all practical purposes, on a single plane and etched onto circuit board 122 material, such as fiberglass or Bakelite. Alternatively the antenna 100 can be injection molded into the container surface, such as the lid of a water meter. The design of the emitting elements produces the low angle of radiation required to attain reliable communications at the low power levels mandated by the FCC for unlicensed usage. Four driven elements 102, 104, 106 and 108 are spaced at 90° increments to provide a uniform horizontally polarized radiation pattern. Although additional elements can be incorporated there is little or no increase in efficiency.

A unique phasing and feed system 110, 112, 114 and 116 combined with an impedance matching network 118 ensure maximum efficiency of the radio frequency energy delivered to the antenna 100 by the transmitter at the connection 120. Each of the driven elements 102, 104, 106 and 108 also has a gama match 111, 113, 115 and 117 that parallels the phasing and feed system 110, 112, 114 and 116. The phasing and feed system 110, 112, 114 and 116 and the impedance matching network 118 are also etched onto the circuit board 122, making the antenna 100 a one-piece assembly. This antenna assembly 100 can be molded into the actual meter cover assembly or manufactured as an independent structure incorporated within the data acquisition unit 26.

The collection unit 14 utilizes an antenna unit 70 that is comprised of two or more of the antenna 100 in a stacked formation as illustrated in FIG. 1, thereby increasing the capture area for increased sensitivity. The configuration of receiving antennas 100 within the antenna unit 70 is based upon the individual receiving requirements necessary in locations where attenuation from terrestrial obstacles needs to be overcome. The terrestrial obstacles can be buildings, trees, traffic patterns, as well as the surrounding topography. The receiving antenna radiation pattern is focused by adding additional parasitic elements as known to those skilled in the art. The receiving antenna array further comprises an inductive loaded reflector element, gammaxial cancel capacitor and/or other related parasitic elements known at the time of manufacture that are needed to lower the reception. and/or transmission angle.

The collection box 50 consists of microprocessor controlled transmitters, receivers, data storage management, and any additional software and/or hardware required for a specific application. Once data is collected by the collection box 50, the data is preferably organized into data blocks based upon source ID and time received. In the preferred embodiment, fault flagging and data checking are included in the process.

In embodiments where the data is sent for processing at a remote centralized server location, the collector box 50, based upon a predetermined schedule, transmits the data blocks. At the server, the data is processed in accordance with the end user's application, as disclosed in co-pending application Ser. No. 09/545,379.

As stated heretofore, when the data acquisition units 12 are manufactured, they are assigned a unique, individual ID. To collect the data, the data collection box 50 needs to know which data acquisitions units 12 are responsible for reporting to that collection box 50. One method of establishing recognition is for the acquisition units to “register” with the collection unit at the initial report transmission. This, however, is not preferable as a faulty unit could never register and, therefore, never be tracked. The preferred method is for the collection unit 50 to be programmed, upon installation of the acquisition unit(s), with the ID code for each acquisition unit. Therefore, in the event of a faulty acquisition unit 26, the collection unit 50 is aware that a transmission has not been received, whether it is the initial or subsequent transmissions, and can notify the server, or other location, of any missing transmission. Both the initial programming and any updating of the collection box can be accomplished remotely through the centralized server or manually, on site, depending upon the type of installation.

In the event two data acquisition units are within transmission distance of multiple data collection units, the duplicate transmissions will be eliminated by the server, based upon the acquisition unit ID. This prevents duplication of records while not having to go to the expense of blocking transmissions at the data collection unit.

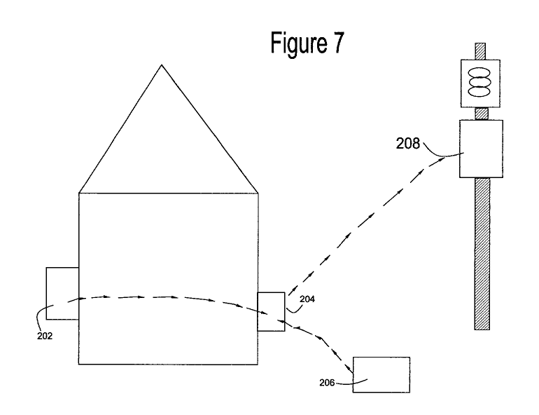

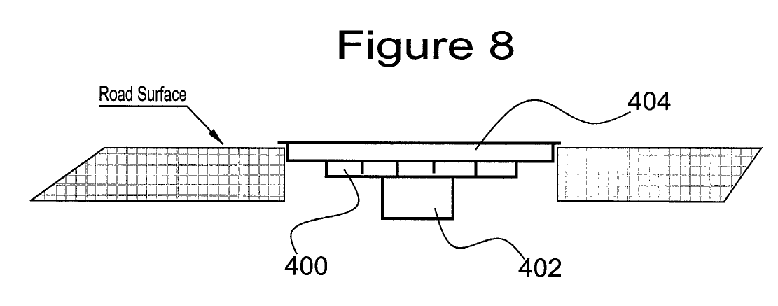

In FIG. 7, a multiple sensor, or meter, design is illustrated. In this figure the electric meter 204 is equipped with a transceiver capable of receiving data from the water meter 206 and the gas meter 202 and transmitting the collected data from all three meters to the collection unit 208. In this embodiment, only the electric meter 204 is required to have sufficient transmission power to transmit the distance to the collection unit 208. The water meter 206 and the gas meter 202 are generally within 200 feet, or less, from the electric meter 204 and therefore do not require the transmitter power necessary to transmit the distance to the collection unit 208. This translates into a lower cost installation than would be required if all meters were required to transmit directly to the collection unit 208.

One problem that is encountered by companies in various fields is the gathering of data from equipment placed within covered underground systems such as manholes. This application presents the problem that there can be no protruding elements used for radiating R.F. signals, as any above surface level element is susceptible to damage or can cause damages to vehicles. In the disclosed antenna feed system 400, a transmitter 402 is secured to the underside of the manhole or utility cover 404. The antenna feed system 400 is a capacitive coupled tapped phased delivery system where the RF energy is fed to the metallic device, typically iron, through discs of the proper area to produce the correct capacitive values to obtain the necessary phase shift and inductance canceling characteristics for the emission of circular polarized energy. Size area and placement will change based on the frequency chosen for the transmission medium. Circular polarization is chosen for the unique noise canceling characteristics and rejection of signals within the same frequency but not of the alike polarization. The localized receiving antenna is a standard helical style with the correct polarity (left or right) to receive the signals from the antenna when coupled to the manhole or utility cover 404. Once the signals are picked up by the collection unit, they are processed as described heretofore.

The data received by the data collection unit can be transmitted, via satellite, to a remote server location that will be utilized to receive, manage, and display the meter readings for each individual utility. The server will distribute the meter readings to an individual utility user's interface for viewing or downloading into any accounting software via the Internet, anywhere in the world, as disclosed in co-pending Ser. No. 09/545,379.

What is claimed is:

1. A data acquisition unit for the collection and transmission of data received from a sensor, said data acquisition unit having:
a sensor interface; said sensor interface receiving signals from said sensor and converting said signals to data signals readable by a microprocessor; said sensor interface sending said data signals to said microprocessor;
a microprocessor; said microprocessor having storage to store said data signals and a transmitter to transmit said data signals to a remote receiver based upon a predetermined schedule;
a power supply; said power supply providing power to said sensor interface and said microprocessor;
an antenna.

2. The data acquisition unit of claim 1 wherein said data acquisition unit is adjacent to said sensor.

3. The data acquisition unit of claim 1 wherein said interface tracks the number of signals received from said sensor.

4. The data acquisition unit of claim 1 wherein said power supply is a battery.

5. The data acquisition unit of claim 1 wherein said data acquisition unit and said sensor are an integral unit.

6. The data acquisition unit of claim 1 wherein said antenna is a multi-element phase collinear horizontal polarized array.

7. The data acquisition unit of claim 1 wherein said preprogrammed schedule is a time domain collision avoidance algorithm.

8. The acquisition unit of claim 1 wherein said transmitter is a transceiver.

9. A data collection and transmission system for the collection of sensor data from multiple remote sensors having:
at least one data acquisition unit for the collection and transmission of data received from a sensor, said data acquisition unit having:
a unique ID,
a sensor interface; said sensor interface being adjacent to and receiving signals from said sensor, tracking the number of signals received from said sensor, converting said signals to data signals readable by a microprocessor and forwarding said data signals to a microprocessor;
a microprocessor; said microprocessor transmitting said data signals and ID, based upon a predetermined schedule, to a remote receiver;
a power supply; said power supply providing power to said sensor interface and said microprocessor; an antenna, a collection unit, said collection unit being remote from said data acquisition unit and having an antenna a data collector, said data collector having a transceiver to receive and transmit said data signals and ID from said microprocessor, a microcontroller to process said data signals and ID, and storage to store said data signals and ID for subsequent analysis, wherein said each of said at least one data acquisition unit transmits said data signals and ID to said collection unit base on a predetermined schedule.

10. The system of claim 9 wherein said antenna is at least two stacked horizontal polarized collinear multi-phased omni directional units, said horizontal polarization enabling said antenna to receive horizontally polarized signals.

11. The system of claim 9 wherein at least two data acquisition units are receiving signals from a single entity, a first of said at least two data acquisition units having a transceiver and an independent power source, said first of said at least two data acquisition units receiving data signals from the remaining at least two data acquisition units and transmitting said data signals from all data acquisition units from said single entity.

12. The system of claim 9 wherein said collection unit transmits said data signals, at predetermined times, to a centralized server at a remote location.

13. The system of claim 9 wherein said collection unit microcontroller further comprises analysis software, said analysis software enabling predetermined control of said data.

14. The system of claim 9 wherein said data collector is programmed with said ID for each of said data acquisition units, thereby enabling said data collector to activate predetermined notifications when one of said data acquisition units does not transmit.

15. The method of avoiding multiple transmissions within the same time domain from multiple transmitters to a single collection unit by using deterministic timing, randomization and duplicate transmission, comprising the steps of:
a. determining a data cycle;
b. determining multiple transmission cycles within said data cycle;
c. determining multiple time slots within said transmission cycle;
d. assigning a time slot to each transmitting unit;
e. assigning each of said transmitting units a unified start time, each of said transmitting units logging time based on said start time;
f. selecting a random transmission period within said time slot to transmit
wherein each of said transmitting units transmits within a randomly selected transmission period within said time slot within each of said transmission cycles within said data cycle.

16. The method of claim 15 wherein said transmitting unit time slot assigned at said unified start time is a first time slot within said transmission cycle.

17. The method of claim 16 wherein on all transmitting units said time slot moves in relation to said first time slot on a predetermined pattern, thereby enabling each transmission to be at a different time from a previous transmission.

18. The method of claim 15 wherein said transmitting unit transmits multiple transmission periods within said time slot.

19. An multi-element phase collinear horizontally polarized array antenna for horizontal transmission having:
a. at least two driven elements, each of said at least two driven elements being etched into a base, each of said driven elements having:
a phasing and feed system, said phasing and feed system being etched into said base; a gamma match, said gamma match being etched into said base;
b. an impedance matching network
c. a signal feed wherein horizontal polarization increases transmission reliability by increasing gain.

20. The antenna of claim 19 wherein multiples of said antenna are stacked to receive horizontally polarized transmissions from a ground level antenna.2
